(19) United States
(12) Patent Application Publication
(10) Pub. No.: US 2010/0263741 A1
(43) Pub. Date: Oct. 21, 2010

(54) FLUID ASSEMBLY

(76) Inventors: Rainer Fuerst, Immenstadt (DE); Alexander Bareiss, Immenstadt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/528,602

(22) PCT Filed: Jan. 9, 2008
(86) PCT No.: PCT/EP08/50189

§ 371 Date: Aug. 25, 2009

(30) Foreign Application Priority Data
Feb. 26, 2007 (DE) 10 2007 009 162.3

(51) Int. Cl. F16K 27/00

(52) U.S. Cl. 137/343

(57) ABSTRACT

The invention relates to a fluid assembly having a fluid block, a controller, and at least one solenoid valve. The solenoid valve has a valve cartridge connected to the fluid block and a corresponding solenoid unit connected to the controller, whereby the controller is connected to the fluid block in a sealing manner via a housing pan. According to the invention, the housing pan has a functionally integrated housing bottom, which is integrated in a magnetic circuit of the at least one solenoid valve and, at least in the pass-through region of the at least one solenoid valve, is made of magnetically conductive material, preferably a metal.

### PRIOR ART

The invention relates to a fluid assembly according to the preamble to the independent claim 1.

Conventional fluid assemblies that are used, for example, in an antilock brake system (ABS), a traction control system (TCR system), or an electronic stability program system (ESP system) are shown in FIGS. 1 and 2; FIG. 1 is a schematic sectional depiction of a region of a fluid assembly in a cap design and FIG. 2 is a schematic sectional depiction of a region of a fluid assembly in a pan design. FIG. 3 shows an exemplary embodiment of a conventional solenoid valve 5, 15 that can be used to regulate the flow of fluid into the fluid assemblies 1, 11 according to FIGS. 1 and 2. FIG. 3 shows a conventional solenoid valve 5, 15 that has a valve cartridge 5.1, 15.1 including a capsule 31, a valve insert 32, an armature 33, a restoring spring 35, and a valve body 36 and has a solenoid unit 5.2, 15.2 including a housing casing 23, a winding support 24, a coil winding 25, electrical connections 27, and a press-fitted cover plate 5.3. A magnetic flux 30 produced by the coil winding is conducted via the housing casing 23, the cover plate 5.3, the valve insert 32, and the armature 33; the magnetic force produced moves the armature 33 toward the valve insert 32 in opposition to the force of the restoring spring 35, thus reducing an air gap 28 between the armature 33 and the valve insert 32. In order to adapt to various diameters of valve cartridge 5.1, 15.1 so as to avoid an excessively large radial secondary air gap, cover plates 5.3 with adapted bore diameters can be press-fitted into otherwise structurally identical solenoid units 5.2, 15.2, resulting in an increased variety of variants, with repercussions on logistics, assembly, and costs.

In an alternative design of the solenoid unit 5.2, 15.2, the magnetic circuit 30 can be axially divided so that only after assembly of the control unit, is the housing casing 23 with the winding support 24 and the coil winding 25 slid onto the cover plate 5.3 affixed to the valve cartridge 5.1, 15.1, thus closing the magnetic circuit 30; in this case, the fastening of the valve cartridge takes up a lot of space.

As is clear from FIGS. 1 and 2, a fluid block 3, 13 with valve cartridges—of which one valve cartridge 5.1, 15.1 is shown—has a control unit 2, 12 attached to it, which includes a cover 2.1, 12.1, a housing wall 4, 14, and a corresponding solenoid unit 5.2, 15.2; the height of the housing wall 4, 14 is essentially determined by the height h1, h2 of the respective solenoid unit 5.2, 15.2.

In the cap design shown in FIG. 1, the solenoid unit 5.2 rests with its cover plate 5.3 directly on the surface of the fluid block 3. In this case, a seal 4.1 for producing a seal between the control unit 2 and the fluid block 3 is situated next to the housing casing 23 of the solenoid unit 5.2. The distance d1 from the longitudinal axis of the solenoid valve 5 to the edge of the fluid block 3 and the corresponding dimensions of the control unit 2 and therefore the amount of space occupied by the entire system are determined by the radius of the solenoid unit 5.2 and the width of the seal 4.1.

In the pan design shown in FIG. 2, the seal 14.1 is situated on the underside of a pan bottom 14.2 that is positioned between the solenoid unit 15.2 and the fluid block 13. As a result, the distance d2 from the longitudinal axis of the solenoid valve 15 to the edge of the fluid block 13 and the corresponding dimensions of the control unit 12 and therefore the amount of space occupied by the entire system are determined only by the radius of the solenoid unit 15.2 and the thickness of the housing wall 14. The shimming of the pan bottom 14.2, however, elevates the position of the solenoid unit 15.2 in relation to the valve cartridge 15.1 so that in order to assure a uniform magnetic flux, the height of the valve cartridge 15.1 is increased by the thickness h3 of the pan bottom 14.2. As a result, the pan design according to FIG. 2 does in fact have a smaller distance d2 between the longitudinal axis of the solenoid valve 15 and the edge of the fluid assembly 13 than the cap design according to FIG. 1, which has the distance d1 between the longitudinal axis of the solenoid valve 5 and the edge of the fluid assembly 3, but the height h2 of the solenoid unit 15.2, however, is greater than the height h1 of the solenoid unit 5.2.

### DISCLOSURE OF THE INVENTION

The fluid assembly according to the invention, with the defining characteristics of the independent claim 1, has the advantage over the prior art that a housing pan by means of which a control unit is connected to a fluid block in a sealed fashion has a functionally integrated housing bottom, which is integrated into a magnetic circuit of at least one solenoid valve and, at least in the pass-through region of the at least one solenoid valve, is composed of a magnetically conductive material, preferably a metal. The housing pan according to the invention advantageously performs the function of the cover plate of the conventional solenoid valve, making it possible to reduce the overall height and overall width and to eliminate the cover plate as a component of the magnetic circuit. At the same time, the possibility for optimally attaching valve cartridges is retained and a favorable seal is produced at the interface between the fluid block and the control unit. In addition, the functionally integrated housing bottom advantageously increases the rigidity of the control unit housing and it is also possible to provide bores for mounting the control unit on the fluid block.

Advantageous improvements of the fluid assembly disclosed in the independent claim 1 are possible by means of the measures and modifications explained in the dependent claims.

It is particularly advantageous for the entire housing bottom and/or the entire housing pan to be composed of the magnetically conductive material, preferably a metal, thus making it possible to further improve the rigidity and fastening possibilities of the control unit housing, particularly in its embodiment as a metal bottom. In order to enlarge the magnetic transition between the solenoid unit and the valve cartridge, the functionally integrated housing bottom can be advantageously provided with collars pointing upward and/or downward in the pass-through region of the at least one solenoid valve. In addition, the solenoid unit and a cover can have elastic elements situated between them, which continuously press the solenoid unit against the housing bottom. This makes it possible to advantageously avoid the occurrence of an undesirable axial air gap between the housing bottom and the solenoid unit, the presence of which weakens the magnetic flux and therefore the resulting magnetic force.

In the embodiment of the fluid assembly according to the invention, the housing pan is attached to the fluid block by means of screws and/or glue and/or rivets. In order to permit a high level of prestressing, the housing bottom is made of metal in the region of a fastening bore for a screw- and/or rivet connection. In a screw- or rivet connection, the screw or rivet, the metal bottom, and the fluid block combine to form a continuous metallic screw- or rivet assembly that permits a high level of prestressing and is not subject to any relaxation phenomena of the plastic; in comparison to a pan made entirely of plastic, it is thus possible to dispense with providing an additional screw bushing.

In another embodiment of the fluid assembly according to the invention, the housing bottom made of metal is extrusion-coated with plastic in the edge region; in this case, a sealing groove is formed in the region of the plastic extrusion coating, thus enabling a space-neutral application of a glue layer or sealing layer that separates the boundary layers of the fluid block and metal housing bottom from the atmosphere, thus preventing the occurrence of corrosion phenomena. In addition, the thickness of the housing bottom in the edge region can be reduced, for example by means of an impression made in it, in order to accommodate the seal. Alternatively, bending the housing bottom upward in the edge region permits a space-neutral accommodation of the peripheral seal. It is also possible for a flat seal to be positioned over the entire surface of the housing bottom. For example, a parting plane between the fluid block and the control unit can extend, for example, between the fluid block and the housing pan or between the housing pan and the control unit.

In another embodiment of the fluid assembly according to the invention, the housing bottom can have a cooling tab bent upward from it in at least one predetermined location in order to embody a thermally conductive path for an electronic component so that heat produced in the electronic component can be advantageously diverted via the cooling tab and housing bottom to the fluid block.

The drawings show advantageous embodiments of the invention that will be described below and, to enable better comprehension of them, conventional embodiments that have been explained above. In the drawings, components and elements that perform the same or analogous functions have been provided with the same reference numerals.

### BRIEF DESCRIPTION OF THE DRAWINGS

FIG. 1 is a schematic sectional depiction of a region of a fluid assembly in a cap design.

FIG. 2 is a schematic sectional depiction of a region of a fluid assembly in a pan design.

FIG. 3 is a schematic sectional depiction of a solenoid valve for the fluid assembly according to FIG. 1 or FIG. 2.

FIG. 4 is a schematic sectional depiction of a housing pan.

FIG. 5 is a schematic sectional depiction of a region of a fluid assembly according to the invention, with the housing pan according to FIG. 4.

FIG. 6 is a schematic sectional depiction of another region of a fluid assembly according to the invention, with the housing pan according to FIG. 4.

FIG. 7 is a depiction of a detail from FIG. 6.

FIG. 8 is a schematic sectional depiction of a region of a fluid assembly according to the invention, with the housing pan according to FIG. 4.

FIG. 9 is a depiction of a detail from FIG. 8.

FIG. 10 is a perspective depiction of an embodiment of a housing pan.

FIG. 11 is a top view of the housing pan according to FIG. 10.

FIG. 12 is a sectional side view of the housing pan along the section line XII-XII from FIG. 11.

FIG. 13 is a top view of another embodiment of a housing pan.

FIG. 14 is a sectional side view of the housing pan along the section line XIV-XIV from FIG. 13.

FIG. 15 is a sectional front view of the housing pan along the section line XV-XV from FIG. 13.

FIG. 16 is perspective depiction of essential components of a fluid assembly with a first parting plane.

FIG. 17 is a perspective depiction of essential components of a fluid assembly with a second parting plane.

### EMBODIMENTS OF THE INVENTION

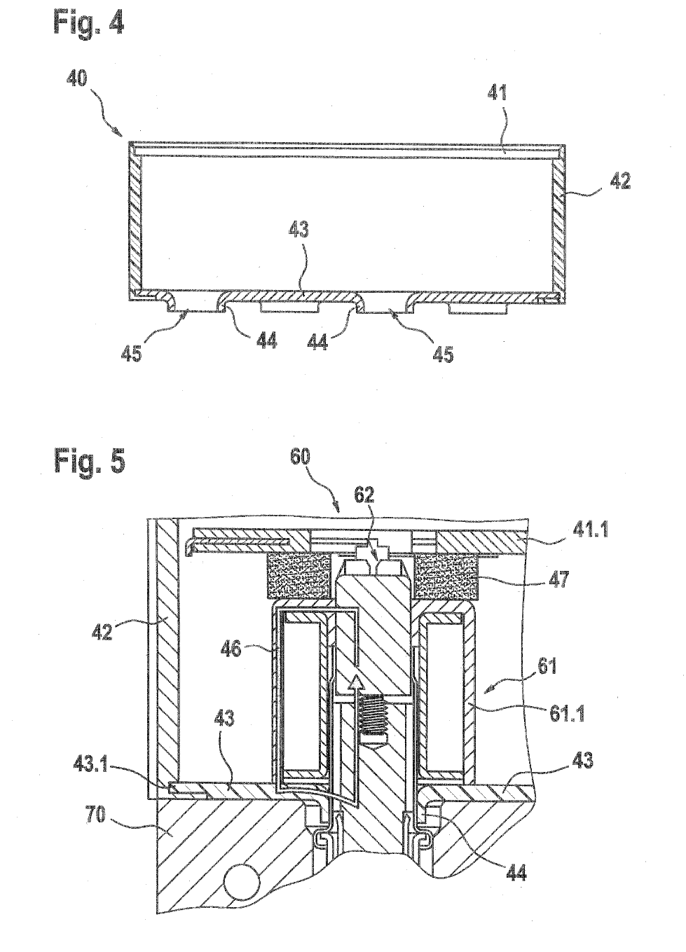

As is clear from FIG. 4, in order to produce a sealed connection between a control unit 50 and a fluid block 70, a housing pan 40 for a fluid assembly 80 according to the invention has a housing frame 42 composed of plastic, a housing cover 41, and a functionally integrated housing bottom 43 that is made of a magnetically conductive material. In the exemplary embodiment shown, the housing bottom 43 is embodied in the form of a metal plate. As is also clear from FIG. 4, the functionally integrated housing bottom 43 has a respective collar 44 protruding downward at each of its pass-through regions 45 for solenoid valves 60; these collars extend the length of a magnetic transition between a solenoid unit 61 and a valve cartridge 62 of the associated solenoid valve 60. Alternatively, the collars in the housing bottom 43 can also point upward.

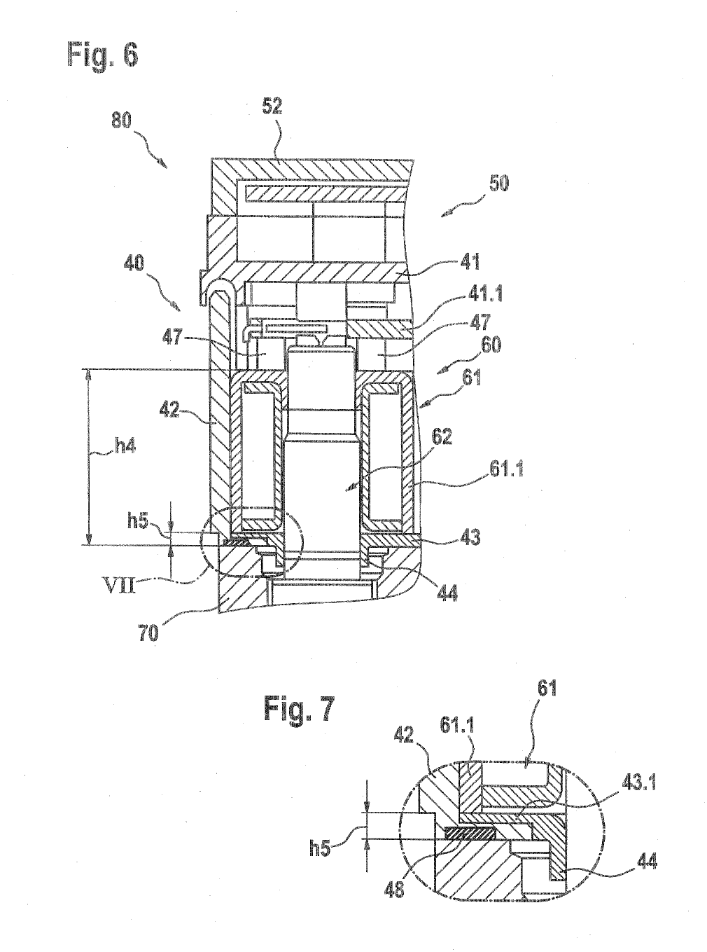

FIG. 5 is a schematic sectional depiction of a region of a fluid assembly 80 according to the invention, with the housing pan 40 according to FIG. 4. As is clear from FIG. 5, compressible elastic elements 47 that are situated between a cover 41.1 and the solenoid unit 61, acting by means of the housing casing 61.1, continuously press the solenoid unit 61 against the housing bottom 43, thus advantageously permitting the magnetic circuit 46 to be built up without axial air gaps between the housing casing 61.1 and the housing bottom 43. As is also clear from FIG. 5, the housing pan 40 is slid with its pass-through region 45 in the housing bottom 43 onto the valve cartridge 62 of the solenoid valve 60, with the valve cartridge 62 resting against the collar 44 in the pass-through region 45 of the housing bottom. Providing the housing bottom 43, which is embodied in the form of a metal plate, with an extrusion coating in its edge region 43.1 makes it possible to form a sealing groove in the plastic, see FIGS. 6 through 9, thus enabling a space-neutral application of a glue layer or sealing layer, which separates the boundary layers of the fluid block 70 and the housing bottom 43 embodied in the form of a metal plate from the atmosphere, thus preventing the occurrence of corrosion phenomena. In addition, the thickness of the housing bottom 43 embodied as a metal plate can be reduced in the edge region 43.1, for example by making an impression made in it. Alternatively, an upward bending in the edge region 43.1 of the housing bottom 43 embodied as a metal plate permits the space-neutral accommodation of a peripheral seal. It is also possible to use a flat seal that extends over the entire surface of the housing bottom 43.

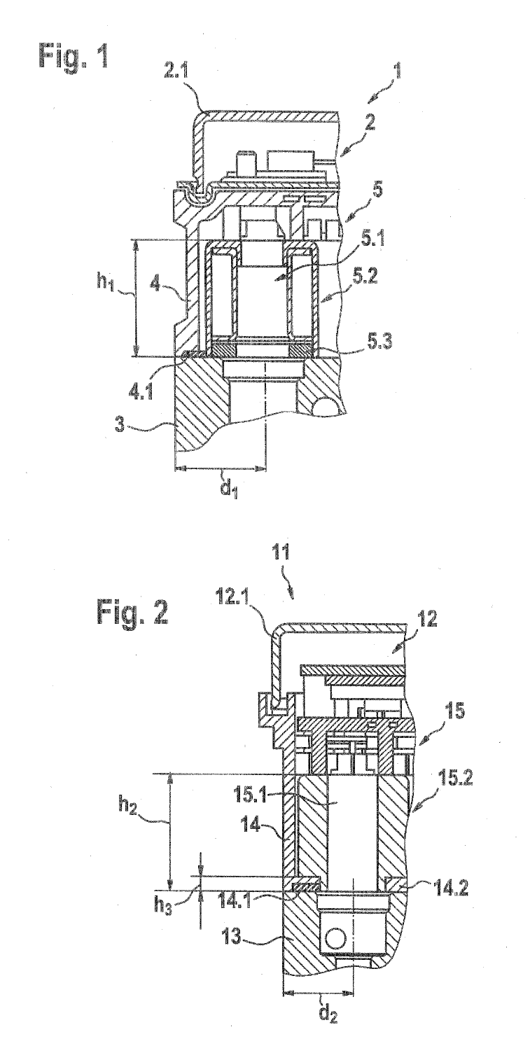

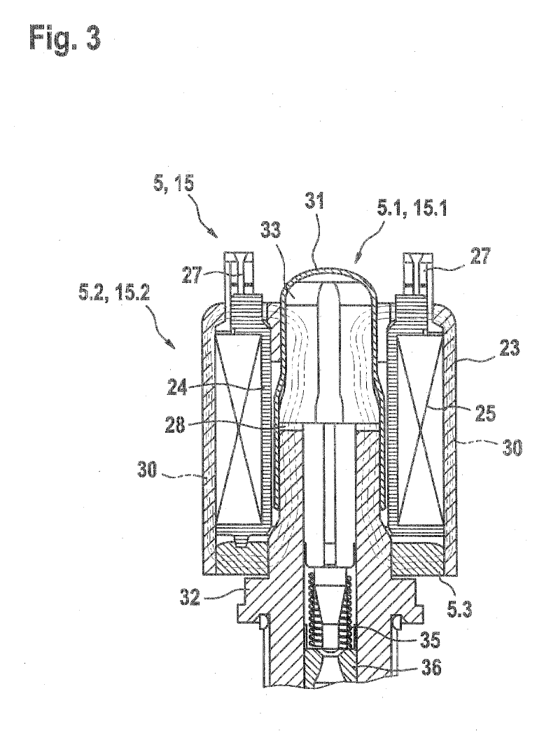

FIG. 6 is a schematic sectional depiction of another region of a fluid assembly according to the invention, with the housing pan according to FIG. 4, and FIG. 7 is a depiction of a detail from FIG. 6. As is clear from FIGS. 6 and 7, analogous to the embodiment shown in FIG. 5, the compressed elastic elements 47, acting by means of the housing casing 61.1, continuously press the solenoid unit 61 against the housing bottom 43. The housing pan 40 is slid with its pass-through region 45 in the housing bottom 43 onto the valve cartridge 62 of the solenoid valve 60, with the valve cartridge 62 resting against the collar 44 in the pass-through region 45 of the housing bottom. A sealing groove in which a seal 48 is accommodated is formed into the plastic of the extrusion-coated edge region 43.1 of the housing bottom 43 embodied in the form of a metal plate. In addition, the thickness of the housing bottom 43 embodied as a metal plate is reduced in the edge region 43.1 by means of an impression made in it. As is also clear from FIGS. 5 and 6, the functionally integrated housing bottom 43 is incorporated into the magnetic circuit 46 of the solenoid valve 60, with the housing bottom 43 performing the function of the cover plate 5.3 of the conventional solenoid valve 5, 15 from FIG. 3, making it possible to reduce the overall height and overall width of the fluid assembly and eliminate the cover plate as a component of the magnetic circuit. This means that despite the presence of the additional housing bottom 43, the height h4 of the solenoid unit 62 is less than the height h1 of the solenoid unit 5.2 from FIG. 1 and less than the height h2 of the solenoid unit 15.2 from FIG. 2. In addition, the distance d3 from the longitudinal axis of the solenoid valve 60 to the edge of the fluid block 70 is less than the distance d1 from the longitudinal axis of the solenoid valve 5 from FIG. 1 to the edge of the fluid block 3 and less than the distance d2 from the longitudinal axis of the solenoid valve 15 from FIG. 2 to the edge of the fluid block 13.

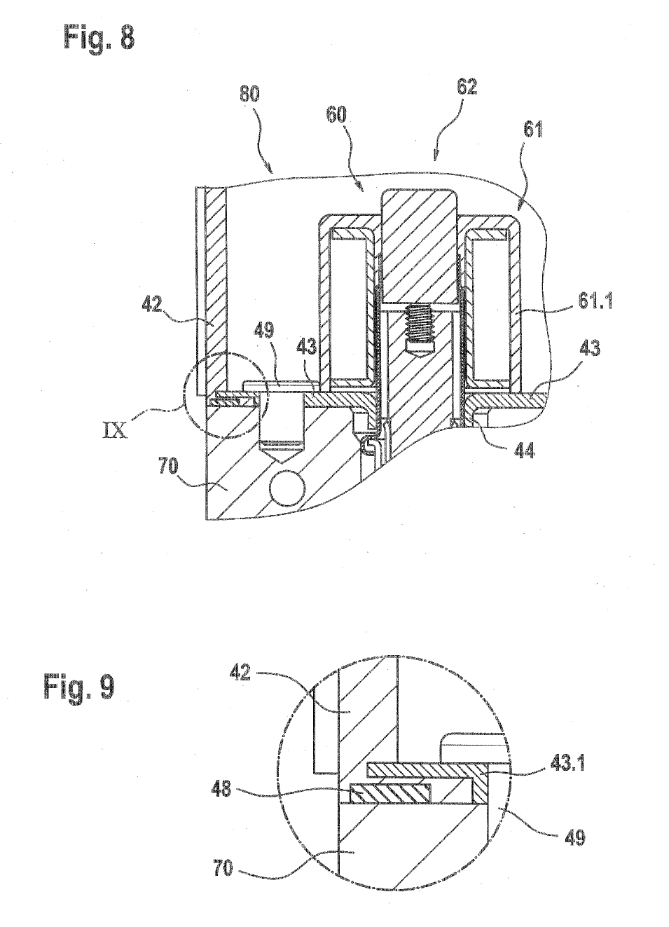

The fastening of the housing pan 40 to the fluid block 70 can be carried out from any direction, for example by means of glue, screws, rivets, etc. As is clear from FIGS. 8 and 9, a fastening element 49 inside the housing pan 40, for example, can be inserted in the direction toward the fluid block 70. In addition or alternatively, a screw can be inserted through the fluid block 70 from the rear and screwed into a thread that is provided in the housing bottom 43. In a screw- or rivet connection, the screw or rivet, the housing bottom 43 embodied as a metal plate, and the fluid block 70 combine to form a continuous metallic screw assembly that permits a high level of prestressing and is not subject to any relaxation phenomena of the plastic. In comparison to a pan made entirely of plastic, it is thus possible to advantageously dispense with providing additional screw bushings. The extrusion coating of the housing bottom 43 embodied in the form of a metal plate produces a sealing groove formed into the plastic in the edge region 43.1, which groove accommodates a seal 48 in a space-neutral fashion. As is also clear from FIG. 9, the thickness of the housing bottom 43 embodied in the form of a metal plate is reduced in the edge region 43.1 by means of an impression made in it.

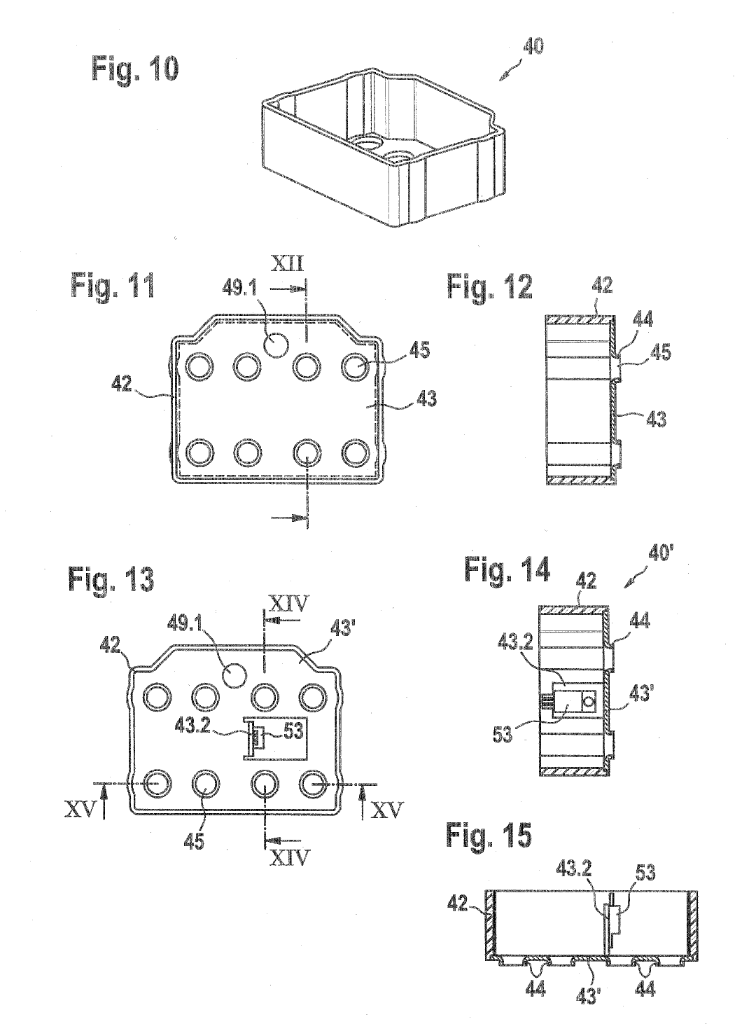

FIGS. 10 through 12 show various depictions of an embodiment of the housing pan 40. As is clear from FIGS. 10 through 12, the housing bottom 43 is provided with eight pass-through regions 45 for valve cartridges, with corresponding collars 44, and one fastening bore 49.1.

FIGS. 13 through 15 show various depictions of another embodiment of the housing pan 40′. As is clear from FIGS. 13 through 15, the housing bottom 43″ is likewise provided with eight pass-through regions 45 for valve cartridges, with corresponding collars 44, and one fastening bore 49.1, in an embodiment analogous to the one according to FIGS. 10 through 12. In addition, the housing bottom 43′ has a cooling tab 43.2 bent upward from it at a predetermined location, to which an electronic component 53 is fastened; this cooling tab constitutes a thermally conductive path that diverts heat produced in the electronic component to the fluid block 70.

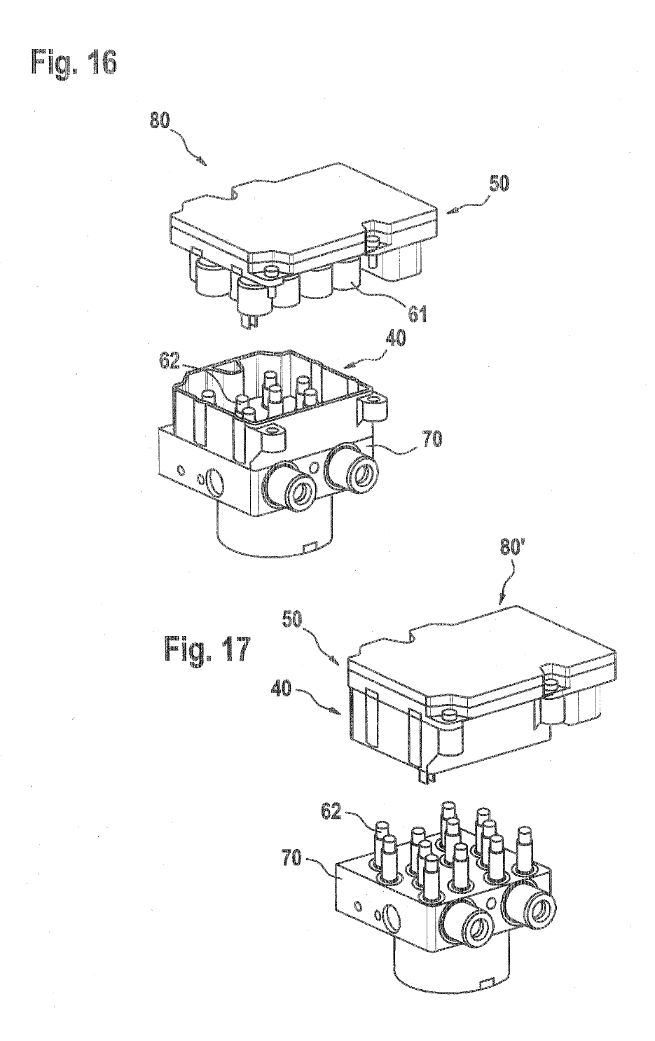

FIG. 16 is a perspective depiction of essential components of a fluid assembly, with a first parting plane that extends between the housing pan 40 and the control unit 50. This means that the control unit 50, together with the solenoid units 61, can be removed from the housing pan 40 that is attached to the fluid block 70 and the valve cartridges 62.

FIG. 17 is a perspective depiction of essential components of a fluid assembly, with a second parting plane that extends between the housing pan 40 and the fluid block 70. This means that the control unit 50, together with the solenoid units 61 and the housing pan 40, can be removed from the fluid block 70 and the valve cartridges 62. The different possible parting planes permit a flexible design of the fluid assembly 80, it being advantageously possible to adapt the parting planes to the given installation conditions.

The fluid assembly according to the invention, with the housing pan and the functionally integrated housing bottom, advantageously reduces the overall height and overall width while retaining the possibilities for optimally attaching valve cartridges and favorably sealing the interface between the fluid block and the control unit. In addition, the functionally integrated housing bottom advantageously increases the rigidity of the control unit housing and it is possible to provide bores for mounting the control unit on the fluid block. Another advantage is that by providing selective openings in the housing bottom according to the invention, it is possible to use a combination of conventional solenoid valves, i.e. solenoid valves that have solenoid units with press-fitted cover plates, and the solenoid valves described here, in which the housing bottom according to the invention performs the function of the cover plate.

1-10. (canceled)

11. A fluid assembly having a fluid block a control unit, and at least one solenoid valve, which solenoid valve includes a valve cartridge situated in the fluid block and a corresponding solenoid unit situated in the control unit, with the control unit being connected to the fluid block in a sealed manner via a housing pan, the housing pan having a functionally integrated housing bottom integrated into a magnetic circuit of the at least one solenoid valve and, at least in a pass-through region of the housing bottom of the at least one solenoid valve, is composed of a magnetically conductive material, preferably a metal.

12. The fluid assembly as recited in claim 11, wherein the entire housing bottom and/or the entire housing pan is composed of the magnetically conductive material, preferably a metal.

13. The fluid assembly as recited in claim 11, wherein the functionally integrated housing bottom has collars pointing upward and/or downward in the pass-through region of the at least one solenoid valve.

14. The fluid assembly as recited in claim 12, wherein the functionally integrated housing bottom has collars pointing upward and/or downward in the pass-through region of the at least one solenoid valve.

15. The fluid assembly as recited in claim 11, further comprising elastic elements that are situated between the solenoid unit and a cover and which elastic elements continuously press the solenoid unit against the housing bottom.

16. The fluid assembly as recited in claim 12, further comprising elastic elements that are situated between the solenoid unit and a cover and which elastic elements continuously press the solenoid unit against the housing bottom.

17. The fluid assembly as recited in claim 13, further comprising elastic elements that are situated between the solenoid unit and a cover and which elastic elements continuously press the solenoid unit against the housing bottom.

18. The fluid assembly as recited in claim 14, further comprising elastic elements that are situated between the solenoid unit and a cover and which elastic elements continuously press the solenoid unit against the housing bottom.

19. The fluid assembly as recited in claim 11, wherein the housing pan is attached to the fluid block by screws and/or glue and/or rivets.

20. The fluid assembly as recited in claim 18, wherein the housing pan is attached to the fluid block by screws and/or glue and/or rivets.

21. The fluid assembly as recited in claim 19, wherein the housing bottom is made of metal in the region of a fastening bore for a screw- and/or rivet connection in order to permit a high level of prestressing.

22. The fluid assembly as recited in claim 20, wherein the housing bottom is made of metal in the region of a fastening bore for a screw- and/or rivet connection in order to permit a high level of prestressing.

23. The fluid assembly as recited in claim 11, wherein the housing bottom made of metal is extrusion coated with plastic in an edge region thereof, with a sealing groove formed therein in the region of the plastic extrusion coating.

24. The fluid assembly as recited in claim 22, wherein the housing bottom made of metal is extrusion coated with plastic in an edge region thereof, with a sealing groove formed therein in the region of the plastic extrusion coating.

25. The fluid assembly as recited in claim 11, wherein in order to accommodate a seal, the thickness of the housing bottom in an edge region thereof is reduced and/or the housing bottom is bent upward in the edge region.

26. The fluid assembly as recited in claim 24, wherein in order to accommodate a seal, the thickness of the housing bottom in an edge region thereof is reduced and/or the housing bottom is bent upward in the edge region.

27. The fluid assembly as recited in claim 11, wherein a parting plane extends between the fluid block and the control unit, between the fluid block and the housing pan, or between the housing pan and the control unit.

28. The fluid assembly as recited in claim 26, wherein a parting plane extends between the fluid block and the control unit, between the fluid block and the housing pan, or between the housing pan and the control unit.

29. The fluid assembly as recited in claim 11, wherein the housing bottom has a cooling tab bent upward therefrom in at least one predetermined location in order to embody a thermally conductive path for an electronic component.

30. The fluid assembly as recited in claim 28, wherein the housing bottom has a cooling tab bent upward therefrom in at least one predetermined location in order to embody a thermally conductive path for an electronic component.
